(19) United States
(12) Patent Application Publication
(10) Pub. No.: US 2016/0335748 A1
(43) Pub. Date: Nov. 17, 2016

(54) METHOD FOR INPAINTING A TARGET AREA IN A TARGET VIDEO

(71) Applicant: THOMSON LICENSING, Issy-les-Moulineaux (FR)

(72) Inventors: Alasdair NEWSON, Beynes (FR); Andres ALMANSA, Paris (FR); Matthieu FRADET, Chanteloup (FR); Yann GOUSSEAI, Paris (FR); Patrick PEREZ, Rennes (FR)

(21) Appl. No.: 15/112,572

(22) PCT Filed: Jan. 22, 2015
(86) PCT No.: PCT/EP2015/051267

§ 371 Date: Jul. 19, 2016

(30) Foreign Application Priority Data
Jan. 23, 2014 (EP) 14305096.1

(51) Int. Cl. G06T 5/00; G06T 7/40; G06T 11/40

(52) U.S. Cl. CPC G06T 5/005; G06T 11/40; G06T 7/408; G06T 2207/10016; G06T 2207/10004; G06T 2207/20016; G06T 2207/10024

(57) ABSTRACT

The invention relates to a method for inpainting a target area in a target video. The method comprises obtaining a multi-resolution representation of the target video, comprising for each resolution, a first video representative of the colors of the target video and a second video representative of the textures of the target video; and for each resolution, reconstructing first and second video in the target area using an information representative of both colors and textures such as to inpaint the target area. The method also relates to a graphics processing unit and to a computer program product for implementing the inpainting method.

### TECHNICAL FIELD

The present invention relates generally to the field of video inpainting. More precisely, the invention relates to a method for inpainting a target area in a target video.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the digital world, inpainting (also known as image completion or video completion) refers to the application of sophisticated algorithms to replace lost or corrupted parts of the image data. Thus the goal of video inpainting is to fill in a space-time hole (also called an occlusion) in a video with some content in a manner which is visually pleasing. This sort of processing is useful for removing unwanted objects or degradations from videos. Some of the challenges of video inpainting include restituting the correct motion of objects which move into the occlusion, and correctly inpainting video textures. These goals require that temporal consistency be taken into account; it is not sufficient to perform image inpainting on a frame-by-frame basis. Most often, inpainting algorithms take video patches from outside the occlusion and copy them in some fashion into the occlusion. While the goal of reconstructing moving objects is reasonably well dealt with in prior work, there has been no algorithm which reconstructs video textures in the generic context of automatic video inpainting.

Y. Wexler et al. disclose in “Space-Time completion of Video” (IEEE Transactions on Pattern Analysis and Machine Intelligence, Vol. 29, N°. 3, March 2007 page 463) a method for the completion of missing information in video based on local structures. This method discloses an heuristic to optimize a global patch-based energy function wherein the energy is the sum of the distance between each patch of the occlusion and its most similar patch outside the occlusion. The patches used are 3D spatio-temporal patches. The optimization relies on a multi-scale iterative process using spatio-temporal pyramids. However, this method shows poor outcome while reconstructing video textures in the generic context of automatic video inpainting. Indeed, the method determines patch matching according to the color similarity. Thus a patch similar in terms of color is matched even if the texture or structure of patches leads to visual artifacts.

A recent image inpainting algorithm proposed in “Exemplar-Based Image Inpainting Using Multi-scale Graph Cuts” by Liu et al. (IEEE transactions on Image Processing, Vol. 22, N°. 5, May 2013 page 1699) uses the gradient and gradient norm to remove ambiguities concerning structure and texture at the coarsest level of a multi-resolution image pyramid. However, if an error occurs in selection of the most similar patch in terms of color and texture at the coarsest level, the propagation of such erroneous starting conditions also leads to visual artifact. In others words, the inpainting technique does not get out of an erroneous local minima in texture matching. The technical issue of correct texture inpainting therefore remains even while considering texture based distances at the coarsest level.

Another image inpainting algorithm described in “Image inpainting using multiresolution wavelet transform” by Deshmukh et al. (International Conference on Communication, Information & Computing Technology, Oct. 19-20, 2012) discloses repairing texture composition and color composition of an image wherein the texture composition is repaired by a global and multi-frequency analysis from a low frequency composition to high frequency composition based on a wavelet transform. However, the texture composition and the color composition are repaired separately as illustrated on FIG. 3 which also raises the issue of correlating of both reconstructions and may also lead to visual artifacts in the inpainting

A method for inpainting an occlusion in video sequences which is well adapted to textures reconstruction is therefore needed.

### SUMMARY OF INVENTION

The present invention provides a multi-resolution video inpainting algorithm which is able to deal with video textures correctly.

The invention is directed to a method for inpainting a target area in a target video. The method comprises obtaining a multi-resolution representation of the target video comprising for each resolution a first video representative of the colors of the target video and a second video representative of the textures of the target video. The method further comprises, for each resolution, reconstructing said first and second videos in the target area using an information representative of both colors and textures such as to inpaint the target area.

Advantageously, reconstructing the second video representative of the textures for each resolution although not required for reconstructing the colors in the first video, improves the perceptual quality of the inpainting. Indeed, the first video representative of the colors is the target video itself while the second video representative of the textures is a tool to drive the reconstruction of the first video.

According to an advantageous characteristic, for each resolution, information representative of both colors and textures comprises at least a most similar patch to a patch in the target area based on a patch distance comprising both a texture distance and a color distance. Advantageously, a same patch of a given resolution is used for reconstructing colors and for reconstructing texture features at this given resolution thus correlating both reconstructions.

According to another advantageous characteristic, the first video comprises for each pixel a color value, the second video comprises for each pixel a texture features value and a distance between two patches is defined on the basis of a comparison between color values and between texture features values of collocated pixels in the two patches. Reconstructing the first video and the second video for each resolution comprises for each current pixel in the target area:
for a patch centered on said current pixel, called centered patch, obtaining the most similar patch in the same resolution that has the smallest distance to the centered patch;
reconstructing a color value for the current pixel by a weighted average of the color value of collocated pixels over all obtained most similar patches to centered patches containing the current pixel; and
reconstructing a texture features value for the current pixel by a weighted average of the texture features value of collocated pixels over all obtained most similar patches to centered patches containing the current pixel.

In other words, all obtained most similar patches corresponding to any centered patches containing the current pixel are used for the both reconstructions. Advantageously, a same weighting is used in both average of colors values and texture features values.

According to various characteristics, either taken alone or in combination:
for a resolution, a patch is an elementary volume (or window) in space and time;
the most similar patch is determined, for a resolution, at a spatial and temporal location wherein each pixel of a patch is known;
the texture distance is weighted in the patch distance;
a texture features value of a pixel of the second video comprises a local average absolute value of the grey-level image gradient;
the image gradient comprises a gradient in an horizontal or in a vertical direction;
obtaining a multi-resolution representation comprises sub-sampling information from the finest resolution to the coarsest resolution; while
reconstructing the multi-resolution representation comprises recursively up-sampling information from the coarsest resolution to the highest resolution.

In another embodiment, the target video comprises a single image, in other words the method for inpainting a video applies to a method for inpainting an image.

According to another aspect, the invention is directed to a graphics processing unit comprising means for executing code instructions for performing the method previously described.

According to another aspect, the invention is directed to a computer program product comprising instructions of program code to inpaint a target area in a target video when the program is executed by one or more processors by performing steps of the method previously described.

According to another aspect, the invention is directed to a computer-readable medium storing computer-executable instructions performing all the steps of the method previously described when executed on a computer.

Any characteristic or variant embodiment described for the method is compatible with the device intended to process the disclosed method, the computer-readable medium or a computer program product.

### BRIEF DESCRIPTION OF DRAWINGS

Preferred features of the present invention will now be described, by way of non-limiting example, with reference to the accompanying drawings, in which:

FIG. 1 illustrates the steps of the method according to an embodiment of the invention;

FIG. 2 illustrates the multi-resolution representation used in an embodiment of the invention;

FIG. 3 illustrates schematically a hardware embodiment of a device adapted for inpainting according to the invention; and

FIG. 4 illustrates schematically reconstruction of a pixel value from patch correspondences according to an embodiment of the invention.

### DESCRIPTION OF EMBODIMENTS

A salient idea of the patch-based multi-resolution video inpainting is to use texture information to identify where the useful information should come from. This texture information is integrated into the patch distance. However, unlike known methods, for each resolution, the video information and the textural information are reconstructed jointly, using the same reconstruction technique. The proposed method inpaints by successively looking for the most similar patches of all patches in the hole, and combining them to give an inpainting solution. This is iterated several times for each resolution.

Advantageously, the method used for searching for similar patches here can be chosen freely among the state-of-the-art methods.

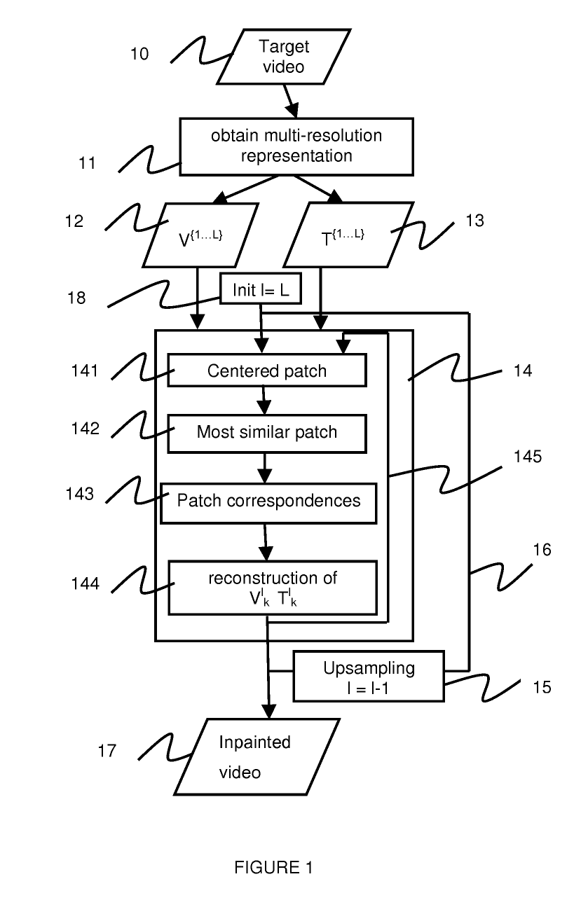

FIG. 1 illustrates the steps of the method according to an embodiment of the invention. Given a target video 10, a space-time hole is specified in the sequence. The inpainting method is required to complete this hole using information from the remainder of the target video. Information about the hole, also known by the skilled in the art as an occlusion or an occluded area (wherein the term area refers to a spatial and temporal location in the target video), is provided to the method. Thus the determination of the occlusion is not in the scope of the invention. For instance, the occlusion is manually defined by a user, it can also be the outcome of some segmentation algorithm. The goal of the method is to determine how to fill in the hole. The target video is also called input video or video to inpaint and the different terms are used indifferently in the following of the description. Besides in the description, the following namings are used: a video comprises a temporal sequence of images; each image of a video comprises a set of pixels; a color value is associated with each pixel. The number of pixels in the image defines the spatial resolution of the video. A pixel is identified with 3 coordinates corresponding to its space and time location in the video.

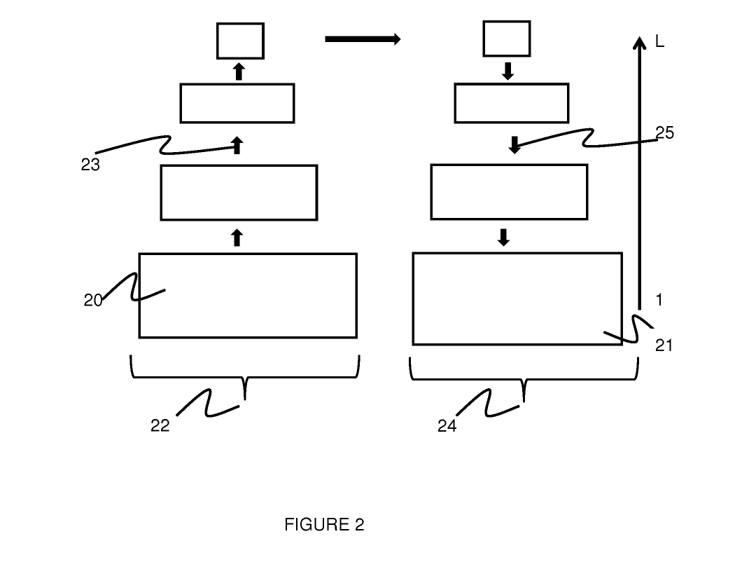

In a first step 11, a multi-resolution representation of the target video is obtained. A multi-resolution or multi-scale signal representation comprises at least a video for each resolution/level of the representation, wherein a resolution/level corresponds to a reduced resolution in the spatial or temporal dimensions of the video. According to a preferred embodiment, a resolution/level corresponds to a reduced resolution in the spatial dimensions of the video. However the invention is compatible with a resolution/level corresponding to a reduced resolution in the temporal dimension of the video or in combination of both reduced resolutions in spatial and temporal dimensions. Such multi-resolution representation is also known in the image processing domain as a multi-resolution pyramid. FIG. 2 illustrates a multi-resolution representation 22, 24 used in the disclosed method. In the multi-resolution representation 22, the L pyramid levels, from the finest level I=1, corresponding to the target video 20, to the coarsest level I=L, are obtained by recursively sub-sampling 23 the video at each level. In the multi-resolution representation 24, the L pyramid levels, from the coarsest level I=L to the finest level I=1, corresponding to the inpainted video 21, are obtained by recursively up-sampling 25 the reconstructed video at each level.

Thus, back to FIG. 1, according to a first characteristic, a Gaussian multi-resolution video pyramid 12 is created from the color pixel value of each image of the target video. Let the first multi-resolution video be noted V^{{1 . . . L}}, with L the number of pyramid levels. Thus for each level I, a first video V^{{I}} representative of the colors of the target video is determined by subsampling video V^{{I-1}}. V^{{I}}(i) represents the color of the pixel i at level I.

Then according to a second characteristic, a second multi-resolution video pyramid 13 is created which corresponds to texture features in the target video noted T^{{1 . . . L}}. T^{{I}} (i) represents the texture features of the pixel i at level I. In a first variant, such texture features are provided to the method at the finest level with the target video and the occlusion information. In a second variant, the method comprises a preliminary step of computing the texture features at the finest pyramid level. Advantageously, such texture features are not limited to one embodiment and a large range of choices is compatible with the inpainting method. For instance, for each pixel in an image of the target video, the texture features value comprises a local estimation of the variance of the textures, or the absolute value of the image gradient (computed on a determined direction such as horizontal direction and/or vertical direction), or the scattering operators as disclosed by J. Bruna in “Classification with Scattering Operators” (in IEEE conference on Computer Vision and Pattern Recognition (CVPR), 2011), or spatio-temporal gradients. Advantageously, these texture features should be as piecewise constant as possible, so as to classify the image into different textural regions. Besides, these regions may then be subsampled safely to coarser resolutions. Once the texture information is calculated at the finest pyramid resolution, it is subsampled for all images to create a second multi-resolution pyramid. Thus for each level I, a second video T^{{I}} representative of the texture of the target video is determined.

For simplification reasons, a single pyramid 22 or 24, either illustrating the first video pyramid 12 representative of the colors or the second video pyramid 13 representative of the texture, is represented on FIG. 2. Pyramid 22 illustrates the L videos obtained by sub-sampling in the determination step while pyramid 24 illustrates the L videos obtained by up-sampling in the reconstruction step. The skilled in the art will appreciate, that the occlusion information is also propagated to each level of representation by sub-sampling. Such occlusion information is, in a non-restrictive embodiment, represented by a mask comprising, for each pixel of video, a binary information corresponding to either occluded pixel or non-occluded pixel. The skilled in the art will also appreciate that neither color values, nor texture features values are available initially inside the occlusion. Accordingly, color values and texture features values are initialized at a determined value for pixels in the occlusion.

According to different variants, a same level of the color pyramid and of the texture pyramid is constructed in parallel or successively in any order but based on a same information. This reconstructing step 14 is particularly well adapted to pixel-wise massive parallel computing. In the reconstructing step 14, both the first multi-resolution video V^{{1 . . . L}} and second multi-resolution video T^{{1 . . . L}} are successively reconstructed using the same approach in the occlusion for each resolution I belonging to [1, L] of the multi-resolution representation. The reconstruction of the color values at the finest level of the pyramid corresponds to the inpainting of the occlusion, thus an inpainted video 17 is obtained. According to a first advantageous characteristic of the invention, the texture features values are reconstructed for each level together with the color values. This characteristic improves the identification of the correct areas from which to take color information. Besides this characteristic, by identifying the texture information, further improves the restitution of the moving objects. According an embodiment of the reconstructing, the target video is split in space-time volumes or windows, called patches, and the reconstruction of color/texture features values for a current pixel relies on a correspondence map which indicates the positions of the patches the most similar to a patch centered on the current pixel. A patch thus comprises a set of pixels of the space-time windows.

The sub-steps of the dual reconstruction of pyramids are now described for a current level I. Accordingly, a resolution iteration loop 16 is performed for each pyramid level from the coarsest level to the finest level.

Thus, at a current level I, in a first sub-step 141, for each current pixel p of the occlusion of a video of a spatio-temporally reduced resolution, a patch centered on the current pixel p is determined. Wₚ denotes a small, fixed-sized window around the pixel p both in space and in time. Thus the patch refers to a location in a video at a current resolution and is independent of the information carried by the video (either representative of color or texture). The size of the window is given as a parameter.

Then in a second sub-step 142, so as to build a correspondence map, a most similar patch W_{q} of the centered patch Wₚ is determined. For example, the most similar patch W_{q} is the window centered around pixel q. A most similar patch W_{q} is selected among candidate patches where candidate patches are located anywhere in space and time in the video. However, for convergence reasons, a candidate patch should not comprise an unknown pixel being either a pixel in the hole or a pixel out of the image boundaries. The similarity of patches is measured in term of a patch distance. A texture information is incorporated into the patch distance known for color information in order to identify the correct areas from which to take video information. In a variant, the patch distance is therefore the sum of square distances (SSD) between two patches including two texture features in addition to two color values. In other words, a distance between two patches is defined on the basis of a comparison between color values and between texture features values of collocated pixels in said two patches, ie pixels that have a same relative spatial and temporal position in the two patches. The invention is however not limited to the SSD variant wherein a distance is defined by the sum of square distances, but is compliant with any definition of the distance such as the sum of absolute value (known as L1 norm), the median of square distances or the largest distance between 2 pixels in each patch. Wₚ and W_{q} are two patches centered on the pixels p and q. The distance according to the SSD variant d(Wₚ,W_{q}) is defined as:

$$d ( {W}_{p} , {W}_{q} ) = {\sum }_{i ∈ {W}_{p} , j ∈ {W}_{q}} {‖ V ( i ) - V ( j ) ‖}_{2}^{2} + α {‖ T ( i ) - T ( j ) ‖}_{2}^{2}$$

Where i and j respectively correspond to pixels belonging to patches Wₚ and W_{q} that have the same spatio-temporal location in patches Wₚ and W_{q}. and where V(i)=V^{{I}}(i) represents the color of the pixel i in Wₚ at level I and T^{{I}}(i)=T^{{I}}(i) represents the texture features of the pixel i in Wₚ at level I (and respectively for a collocated pixel j in W_{q}).

Advantageously α is a scalar which balances the importance of the texture features. The distance including a texture features information prevents the method from replacing video textures by the smooth regions of the video, thus the method reduces visible visual artefacts. As mentioned before, the textural information is compatible with a wide range of choices.

Then in a third sub-step 143, the correspondence map φ is determined. The correspondence map φ^{I} at the level I is a set of patch correspondences for each pixel p of the target area, wherein a patch correspondence comprises the most similar patch W_{q} centered on q and the patch centered on p, wherein the similary is measured by the previously described patch distance and wherein a most similar patch is a patch for which the distance to the centered patch is the shortest. Such correspondence map φ^{I} is for example defined as a vector field. Any state of the art method for determining patch correspondences and building a correspondence map is compatible with the invention.

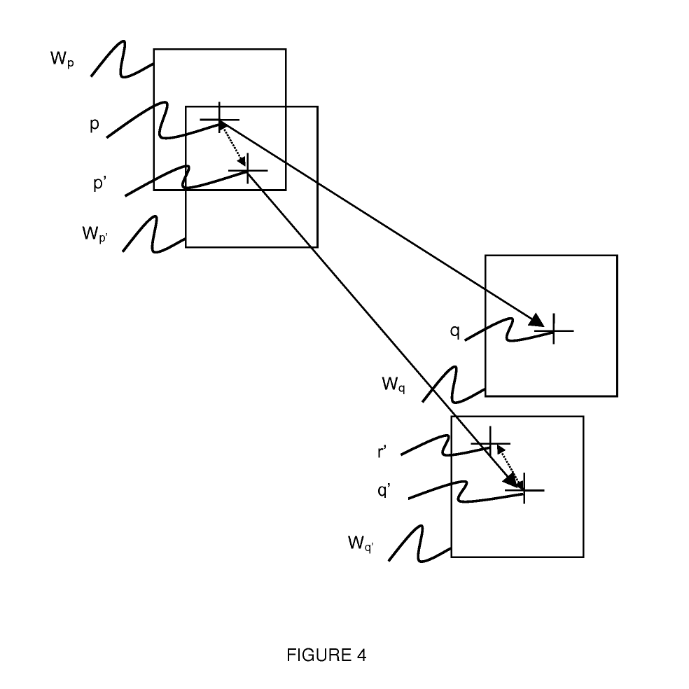

Finally in a fourth sub-step 144, a color value and a texture features value for each pixel p in the occlusion are reconstructed using the correspondence map φ. FIG. 4 illustrates schematically reconstruction of a pixel value from patch correspondences according to an embodiment of the invention. Let us consider all N patches Wₚⁿ containing the current pixel p, this includes Wₚ centered on current pixel p but also neighbouring patches W_{p′} of Wₚ which also contain the current pixel p. Then, from the correspondence map φ, let us consider all the most similar patches W_{q}ⁿ to all N patches Wₚⁿ. As for Wₚ, this includes W_{q} centered on a pixel q which is the patch the most similar to the patch centered on the current pixel p and patches W_{q′} the most similar to neighbouring patches W_{p′}. A value (for color and for texture features) need to be computed from the most similar patches W_{q}ⁿ. Values at pixels rⁿ in patches W_{q}ⁿ spatio-temporally collocated with the current pixel p in patches Wₚⁿ are considered. A pixel r′ in patch W_{q′} spatio-temporally collocated with pixel p in patch W_{p′} is a pixel whose spatio-temporal location in W_{q′} is the same than the one of p in W_{p′}. According to an embodiment, a weighted average of the color values of collocated pixels r in each most similar patch corresponding to a centered patch containing the current pixel p is computed. Besides, a weighted average of the texture features values of collocated pixels in each most similar patch corresponding to a centered patch containing the pixel p is computed. Each current pixel is iteratively reconstructed from the correspondence map φ.

According to an advantageous characteristic, the sub-steps 141 to 144 are iteratively processed at a current resolution I until a convergence level is reached. In a variant, the convergence level is defined by an average pixel value change wherein the difference between the values is below a determined threshold. In a complementary variant, the number of iterations K is below a determined threshold for instance 5. At a current iteration k, the sub-steps for current resolution I are represented by the following equations:

φₖ₊₁^{I}←NearestNeighborSearch(Vₖ^{I},Tₖ^{I})

Vₖ₋₁^{I}←Reconstruction(Vₖ^{I},φₖ₋₁^{I})

Tₖ₊₁^{I}←Reconstruction(Tₖ^{I},φₖ₊₁^{I})

Accordingly, a convergence iteration loop 145 is performed at each pyramid level for reconstruction convergence. The skilled in the art will appreciate that the correspondence map φ^{I} allows linking V^{I} and T^{I}. The skilled in the art will further appreciate that a convergence iteration loop (comprising sub-steps 141, 142 and 143) may also be implemented for correspondence map convergence according to the state-of-the art methods for determining a correspondence map.

The skilled in the art will also appreciate that neither color values, nor texture features values are available initially inside the occlusion. Accordingly, color values and texture features values are initialized 18 at a determined value for pixels in the occlusion. Advantageously, for first iteration at the coarsest level, an onion-peel approach is adopted consisting in firstly inpainting pixels at the border of the occlusion and progressively inpainting pixels inside the occlusion. One layer of the occlusion is inpainted at a time, each layer being one pixel thick. For each pixel p of the current layer, a patch Wₚ centered on this current pixel is determined. Its most similar patch W_{q} is determined using a partial patch comparison, meaning that according to the sum of square differences variant of the patch distance previously defined, the sum is only computed over the pixels of Wₚ with available color/texture features values. Then, to reconstruct the color (resp. texture features) value of current pixel p, a weighted mean of the color (resp. texture features) values of pixels rⁿ collocated with p in each most similar patch corresponding to a patch containing the current pixel p and centered on a pixel with available color (resp. texture features) value is computed.

In a further up-sampling step 15, V^{I} and T^{I} at the current resolution I are up-sampled for determining V^{I-1} and T^{I-1} at the next resolution I−1. To that end, the correspondence map ₉¹ is up-sampled from one level Ito the successive one I−1. The up-sampled correspondence map φ^{I-1} is used to reconstruct V^{I-1}₀ and T^{I-1}₀ which are then used as initial pyramid values for the resolution I−1. Thus the multi-resolution representation is recursively reconstructed 14 and up-sampled 15 from the coarsest resolution to the finest resolution for each pyramid level as represented on FIG. 2. Advantageously the reconstruction of all pyramid levels improves the texture inpainting, since the texture is smoothed at the coarsest level.

The disclosed method has the advantage of being a unified inpainting framework where no segmentation of the video into background, foreground, moving video objects or textured/non textured areas is necessary.

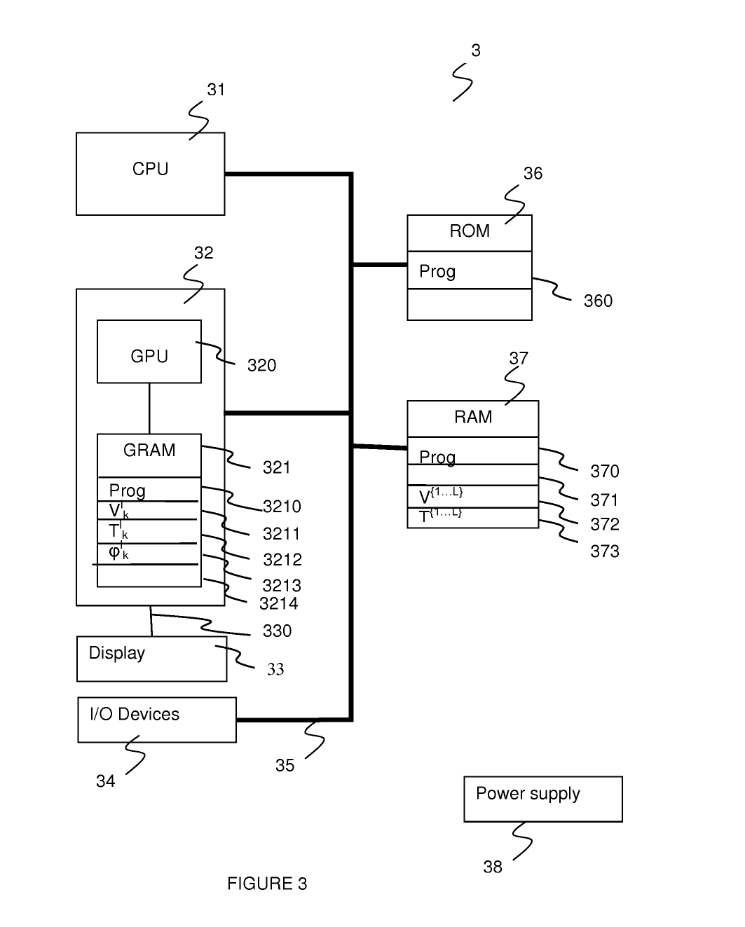

The skilled person will also appreciate that as the method can be implemented quite easily without the need for special equipment by devices such as PCs. According to different variant, features described for the method are being implemented in software module or in hardware module. FIG. 3 illustrates schematically a hardware embodiment of a device 3 adapted for inpainting occlusion in a video. The device 3 corresponds for example to a personal computer, to a laptop, to a game console or to any image processing unit. The device 3 comprises following elements, linked together by an address and data bus 35:
a microprocessor 31 (or CPU);
a graphical card 32 comprising:
   several graphical processing units 320 (CPUs);
   a graphical random access memory 321;
a non volatile memory such as ROM (Read Only Memory) 36;
a RAM (Random Access memory) 37;
one or several Input/Output (I/O) devices 34, such as for example a keyboard, a mouse, a webcam, and so on;
a power supply 38.

The device 3 also comprises a display device 33 such as a display screen directly connected to the graphical card 32 for notably displaying the rendering of images computed and composed in the graphical card for example by a video editing tool implementing the inpainting according to the invention. According to a variant, the display device 33 is outside the device 3.

It is noted that the word “register” used in the description of memories 32, 36 and 37 designates in each of the memories mentioned, a memory zone of low capacity (some binary data) as well as a memory zone of large capacity (enabling a whole programme to be stored or all or part of the data representative of computed data or data to be displayed).

When powered up, the microprocessor 31 loads and runs the instructions of the algorithm comprised in RAM 37.

The memory RAM 37 comprises in particular:
in a register 370, a “prog” program loaded at power up of the device 3;
data 371 representative of the target video and associated occlusion information;
data 372 representative of the color multi-resolution pyramid V^{{1 . . . L}} of the target video;
data 373 representative of the texture features multi-resolution pyramid T^{{1 . . . L}} of the target video.

The core of the disclosed inpainting method is “embarrassingly parallel”, since the calculation of the texture features is done for each pixel independently at the finest pyramid level, and the subsequent subsampling can be easily done in a parallel manner for each coarser level. The reconstruction steps are immediately parallelisable. Thus algorithms implementing the steps of the method of the invention are stored in memory GRAM 321 of the graphical card 32 associated to the device 3 implementing these steps. When powered up and once the data 371 representative of the target video have been loaded in RAM 37, GPUs 320 of the graphical card load these data in GRAM 321 and execute instructions of these algorithms under the form of micro-programs called “shaders” using HLSL language (High Level Shader Language), GLSL language (OpenGL Shading Language) for example.

The memory GRAM 321 comprises in particular data for a current resolution iteration such as:
in a register 3210, data representative of color V^{I}ₖ for a current convergence iteration;
in a register 3220, data representative of texture features T^{I}ₖ for a current convergence iteration;
in a register 3220, data representative of a correspondence map φ^{I}ₖ for a current convergence iteration;

According to a variant, the power supply is outside the device 7.

The invention as described in the preferred embodiments is advantageously computed using a Graphics processing unit (GPU) on a graphics processing board.

The invention is also therefore implemented preferentially as software code instructions and stored on a computer-readable medium such as a memory (flash, SDRAM . . . ), said instructions being read by a graphics processing unit.

The foregoing description of the embodiments of the invention has been presented for the purposes of illustration and description. It is not intended to be exhaustive or to limit the invention to the precise form disclosed. Persons skilled in the relevant art can appreciate that many modifications and variations are possible in light of the above teaching. It is therefore intended that the scope of the invention is not limited by this detailed description, but rather by the claims appended hereto.

1. A method for inpainting a target area in a target video comprising:
obtaining a multi-resolution representation of said target video comprising for each resolution a first video representative of the colors of the target video and a second video representative of the textures of the target video; and
for each resolution, reconstructing said first and second videos in the target area using an information representative of both colors and textures such as to inpaint said target area.

2. The method of claim 1 wherein, for each resolution, said information representative of both colors and textures comprises at least a most similar patch of a patch in the target area based on a patch distance comprising both a texture distance and a color distance.

3. The method according to claim 2 wherein said first video comprises for each pixel a color value and said second video comprises for each pixel a texture features value, wherein said patch distance between two patches is defined on the basis of a comparison between color values and between texture features values of collocated pixels in said two patches and wherein, at each resolution, said reconstructing comprises for each current pixel in said target area:
for a patch centered on said current pixel, obtaining the most similar patch in the same resolution that has the smallest distance to the centered patch;
reconstructing a color value for said current pixel by a weighted average of the color values of collocated pixels over all obtained most similar patches to centered patches containing said current pixel; and
reconstructing a texture features value for said current pixel by a weighted average of the texture features values of collocated pixels over all obtained most similar patches to centered patches containing said current pixel.

4. The method according to claim 2, wherein, for a resolution, said patch is an elementary volume in space and time.

5. The method according to claim 2, wherein the most similar patch is determined, for a resolution, at a spatial and temporal location wherein each pixel of a patch is known.

6. The method according to claim 2, wherein the texture distance is weighted in said patch distance.

7. The method according to claim 1, wherein a texture features value of a pixel of said second video comprises a local average absolute value of the grey-level image gradient.

8. The method according to claim 1, wherein obtaining a multi-resolution representation comprises sub-sampling information from the finest resolution to the coarsest resolution.

9. The method according to claim 1, wherein said reconstructing comprises recursively up-sampling information from the coarsest resolution to the highest resolution.

10. The method according to claim 1, wherein said target video comprises a single image.

11. A graphics processing unit comprising one or more processors configured to:
obtain a multi-resolution representation of a target video comprising, for each resolution, a first video representative of the colors of the target video and a second video representative of the textures of the target video; and
for each resolution, reconstruct said first and second video in a target area using an information representative of both colors and textures such as to inpaint said target area in said target video.

12. The graphics processing unit according to claim 11 wherein, for each resolution, said information representative of both colors and textures comprises at least a most similar patch of a patch in the target area based on a patch distance comprising both a texture distance and a color distance.

13. The graphics processing unit according to claim 11 wherein said first video comprises for each pixel a color value and said second video comprises for each pixel a texture features value, wherein said patch distance between two patches is defined on the basis of a comparison between color values and between texture features values of collocated pixels in said two patches and wherein, at each resolution and for each current pixel in said target area, said one or more processors are configured to:
for a patch centered on said current pixel, obtain the most similar patch in the same resolution that has the smallest distance to the centered patch;
reconstruct a color value for said current pixel by a weighted average of the color values of collocated pixels in over all obtained most similar patches to centered patches containing said current pixel; and
reconstruct a texture features value for said current pixel by a weighted average of the texture features values of collocated pixels over all obtained most similar patches to centered patches containing said current pixel.

14. A computer program product comprising instructions of program code to inpaint a target area in a target video when the program is executed by one or more processors, the program code being configured to:
obtain a multi-resolution representation of said target video comprising, for each resolution, a first video representative of the colors of the target video and a second video representative of the textures of the target video; and
for each resolution, reconstruct said first and second video in a target area using an information representative of both colors and textures such as to inpaint said target area in said target video.

15. The computer program product according to claim 14 wherein, for each resolution, said information representative of both colors and textures comprises at least a most similar patch of a patch in the target area based on a patch distance comprising both a texture distance and a color distance.

16. The computer program product according to claim 15 wherein said first video comprises for each pixel a color value and said second video comprises for each pixel a texture features value, wherein said patch distance between two patches is defined on the basis of a comparison between color values and between texture features values of collocated pixels in said two patches and wherein, at each resolution and for each current pixel in said target area, said program code being configured to:
for a patch centered on said current pixel, obtain the most similar patch in the same resolution that has the smallest distance to the centered patch;
reconstruct a color value for said current pixel by a weighted average of the color values of collocated pixels in over all obtained most similar patches to centered patches containing said current pixel; and
reconstruct a texture features value for said current pixel by a weighted average of the texture features values of collocated pixels over all obtained most similar patches to centered patches containing said current pixel.
